(19) United States
(12) Patent Application Publication
(10) Pub. No.: US 2014/0052635 A1
(43) Pub. Date: Feb. 20, 2014

(54) TIME-SENSITIVE READABLE INDICIA FOR FUNDRAISING

(71) Applicants: Glenn Grossman, Matthews, NC (US); Peter John Bertanzetti, Charlotte, NC (US); Alicia C. Jones, Fort Mill, SC (US); Laura Corinne Bondesen, Charlotte, NC (US); Matthew A. Calman, Charlotte, NC (US); David M. Grigg, Rock Hill, SC (US)

(72) Inventors: Glenn Grossman, Matthews, NC (US); Peter John Bertanzetti, Charlotte, NC (US); Alicia C. Jones, Fort Mill, SC (US); Laura Corinne Bondesen, Charlotte, NC (US); Matthew A. Calman, Charlotte, NC (US); David M. Grigg, Rock Hill, SC (US)

(73) Assignee: BANK OF AMERICA CORPORATION, Charlotte, NC (US)

(21) Appl. No.: 13/589,308

(22) Filed: Aug. 20, 2012

(51) Int. Cl. G06Q 20/40

(52) U.S. Cl. 705/44

(57) ABSTRACT

Embodiments of the invention are directed to systems, methods and computer program products for processing readable indicia for fundraising. An exemplary system is configured to receive information associated with readable indicia associated with a non-profit organization; and process the readable indicia to authorize a payment to the non-profit organization. The readable indicia is valid for a predetermined period. Additionally, the readable indicia enables tracking of various types of information associated with fundraising.

### BACKGROUND

There is a need for non-profit organizations to efficiently collect and track payments.

### BRIEF SUMMARY

Embodiments of the invention are directed to systems, methods and computer program products for processing readable indicia associated with fundraising. An exemplary apparatus comprises a memory; a processor; and a computing module stored in the memory, executable by the processor, and configured to: receive information associated with readable indicia associated with a non-profit organization; and process the readable indicia to authorize a payment to the non-profit organization, wherein the readable indicia is valid for a predetermined period.

In some embodiments, the readable indicia is associated with an agent of the non-profit organization, wherein the readable indicia enables tracking of payments associated with the agent.

In some embodiments, the readable indicia is associated with a geographical area, wherein the readable indicia enables tracking of payments associated with the geographical area.

In some embodiments, the readable indicia is associated with at least of a financial institution account or an alias, wherein the payment is issued to the at least one of the financial institution account or the alias.

In some embodiments, the readable indicia is associated with at least one of an item of value or a cause, and wherein the readable indicia enables tracking of payments associated with the at least one of the item of value or the cause.

In some embodiments, the readable indicia is associated with a predetermined minimum payment and a predetermined maximum payment, wherein the module is configured to reject a payment lesser than the predetermined minimum payment or greater than the predetermined maximum payment.

In some embodiments, the readable indicia limits a number of payments such that the number of payments is not greater than a predetermined number.

In some embodiments, when a period between the module receiving the information associated with the readable indicia and the processing of the readable indicia exceeds a predetermined period, the payment is rejected.

In some embodiments, the readable indicia is associated with a geographical area, and if the module receives the information associated with the readable indicia outside the geographical area, the payment is rejected.

In some embodiments, the readable indicia is associated with a geographical area, and if the module receives the information associated with the readable indicia in the geographical area but the payment is submitted outside the geographical area, the payment is rejected.

In some embodiments, the readable indicia comprises a Quick Response (QR) code.

In some embodiments, the apparatus comprises a portable mobile communication apparatus that comprises an image-capturing component, and wherein the image of the readable indicia is captured by the portable mobile communication apparatus, wherein the processing occurs either inside or outside the portable mobile communication apparatus.

In some embodiments, the readable indicia comprises electronic readable indicia, and the electronic readable indicia is transmitted via at least one of email or text or multimedia message, or is presented via a portable mobile communication device associated with an agent of the non-profit organization.

In some embodiments, the readable indicia comprises physical readable indicia, and the physical readable indicia is printed on an object.

In some embodiments, the module is further configured to: extract a link from the readable indicia; and initiate a user interface associated with the link.

In some embodiments, the user interface comprises a user interface associated with a user's account, wherein the module is further configured to receive authentication credentials to the user's account, and the module is configured to populate a payment form based on information associated with the user's account, wherein the account comprises a financial institution account.

In some embodiments, the module is further configured to issue the payment to a destination account associated with the non-profit organization after clearance of the payment.

In some embodiments, the module is further configured to: receive authentication credentials associated with the payment; and wherein the module configured to process the readable indicia is further configured to process the readable indicia and the authentication credentials to authorize the payment.

In some embodiments, the authentication credentials are input by a user of the portable mobile communication apparatus.

In some embodiments, the authentication credentials are first authentication credentials, and second authentication credentials are comprised in the readable indicia.

In some embodiments, the module is further configured to: extract the second authentication credentials from the readable indicia; and determine whether the first authentication credentials match the second authentication credentials.

In some embodiments, the module is configured to determine whether the authentication credentials match second authentication credentials accessed by the apparatus.

In some embodiments, the module is further configured to initiate an authentication prompt for receiving the authentication credentials in response to receiving the information associated with the readable indicia.

In some embodiments, the readable indicia is comprised in a tag that transmits information wirelessly.

In some embodiments, a method is provided for processing readable indicia for fundraising. The method comprises receiving information associated with readable indicia associated with a non-profit organization; and processing the readable indicia to authorize a payment to the non-profit organization, wherein the readable indicia is valid for a predetermined period.

In some embodiments, a computer program product is provided for processing readable indicia for fundraising. The computer program product comprises a non-transitory computer-readable medium comprising a set of codes for causing a computer to receive information associated with readable indicia associated with a non-profit organization; and process the readable indicia to authorize a payment to the non-profit organization, wherein the readable indicia is valid for a predetermined period.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing readable indicia, in accordance with embodiments of the present invention; and

FIG. 2 is a block diagram illustrating technical components of a system for processing readable indicia, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for processing readable indicia for fundraising. The invention enables a donor to make a donation via a mobile device, and also enables a non-profit organization to organize and track donations. As used herein, the readable indicia comprises a code (e.g., barcode, Quick Response (QR) code, or the like). As used herein, a payment to a non-profit organization or to a fund may be referred to as a donation.

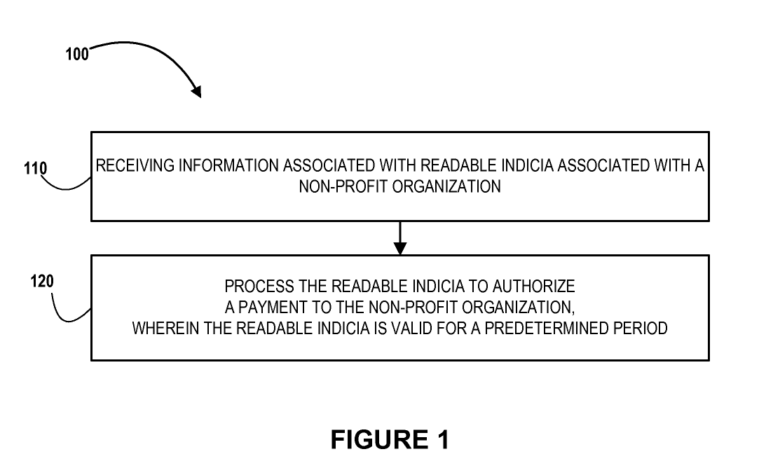

Referring now to FIG. 1, a general process flow 100 is provided for processing readable indicia for fundraising. At block 110, the method comprises receiving information associated with readable indicia associated with a non-profit organization. The readable indicia may be associated with a donation request. For example, an agent (e.g., a person) of a non-profit organization may approach a user (e.g., the donor) requesting a donation to a fund associated with the non-profit organization. The agent may present electronic readable indicia on the agent's mobile device. Alternatively, the electronic readable indicia may be transmitted to the user via email or multimedia or text message. Alternatively, the agent may present physical readable indicia located on a physical object or paper. The non-profit organization issues unique readable indicia to each agent of the non-profit organization. Therefore, the non-profit organization may track donations (e.g., amounts or the like) associated with each agent. Additionally, each agent (or each readable indicia) may be associated with a separate geographical location. Therefore, the non-profit organization may track donations with different geographical localities. Alternatively, the readable indicia may be presented to a user without an agent (e.g., the readable indicia is presented on television, billboard, newspaper, webpage, email, text or multimedia message, or the like).

In some embodiments, the agent may present multiple readable indicia (electronic or physical) to the user. Each readable indicia may be associated with a different payment amount, a different cause, a different account (e.g., financial institution account), a different geographical area of validity, a different period of validity, a different item of value, a different number of users that can make a donation, or the like. The various aspects associated with the readable indicia are described below.

Each readable indicia issued by the non-profit organization may be associated with a different account (e.g., financial institution account) associated with the agent or the non-profit organization. Therefore, a donation is deposited to an account (e.g., a chip-in account) associated with the readable indicia. Additionally, each readable indicia may be associated with a different alias (e.g., phone number, email address, social networking account or the like). Therefore, the user may make a donation by transmitting a payment to an alias associated with the readable indicia. In some embodiments, when the readable indicia is processed by the user's mobile device, the user's mobile device presents options to transmit the user's payment to at least one of a phone number (e.g., via text message), email address, social networking account, or financial institution account associated with the readable indicia.

In some embodiments, the user makes a payment (or a donation) by purchasing an item of value (e.g. popcorn) from an agent of the non-profit organization. In some embodiments, the readable indicia may be associated with a particular item of value (e.g., first readable indicia for popcorn, second readable indicia for cookies, or the like). Using information associated with the readable indicia, the non-profit organization may be able track the sales associated with the various items of value to determine which items are most popular with users. In some embodiments, the readable indicia may be associated with a particular fund associated with a particular cause. In some embodiments, the non-profit organization may permit the user to make donations to one or more causes. Therefore, if the user wants to donate to a particular cause, the non-profit organization's agent generates readable indicia associated with that particular cause on the agent's mobile device. Using information associated with the readable indicia, the non-profit organization may be able to track donation amounts associated with various causes.

The readable indicia may be valid for a certain temporary time period (e.g, a few hours or days). Therefore, if the user receives the readable indicia using the user's mobile device after the time period expires, the readable indicia cannot be processed to make a donation as described herein. Additionally, the mobile device may present a message indicating to the user that the time period associated with the readable indicia has expired.

The readable indicia may permit a donation amount that falls within a certain range. Therefore, if the user attempts to make a donation lesser than a predetermined minimum amount or greater than a predetermined maximum amount, the readable indicia cannot be processed to make a donation. Additionally, the mobile device may present a message indicating the donation attempted by the user does not fall within the range of valid amounts, and the message may indicate the range of valid amounts (e.g., the maximum amount and the minimum amount). Additionally, in some embodiments, the readable indicia may be associated with predetermined donation amounts (e.g., $10, $20, or the like). Therefore, the user may be unable to make donations associated with amounts other than the predetermined amounts.

Additionally, in some embodiments, the readable indicia (or the account associated with the readable indicia) may be associated with a maximum total donation amount associated with all users who have made donations by receiving and processing the readable indicia (e.g., $1000). Therefore, the user may be unable to make a donation if the user's donation would cause the total donation amount associated with the readable indicia to exceed the maximum total donation amount. Additionally, the mobile device may present a message indicating the donation attempted by the user has failed because the user's donation would cause the total donation amount associated with the readable indicia to exceed a maximum total donation amount.

Additionally, the readable indicia may be used by a predetermined number of users to make a donation (e.g., twenty users). Therefore, when the twenty-first user receives the readable indicia at a mobile device in order to make a donation, the readable indicia cannot be processed to make a donation. Additionally, the mobile device may present a message indicating the donation attempted by the user has failed because the readable indicia has exhausted the total number of users who can make a donation associated with the readable indicia.

Additionally, the readable indicia may be associated with a certain geographical area (e.g., a certain zip code, address, radius from a certain point, or the like). Therefore, the user may make a donation if the user receives the readable indicia within a valid geographical area and submits the donation (e.g., immediately or within a predetermined time period) within the valid geographical area. If the user receives the readable indicia within a valid geographical area, and does not submit the donation within the valid geographical area (e.g., submits the donation outside the valid geographical area), the readable indicia cannot be processed to make a donation. A rejection message may be presented on the user's mobile device indicating the donation is rejected because the user has submitted the donation outside the area of validity associated with the readable indicia. Alternatively or additionally, in some embodiments, if the user receives the readable indicia outside the valid geographical area, the readable indicia cannot be processed regardless of whether or not the user returns to the area of validity when submitting the donation. A rejection message may be presented on the user's mobile device indicating the donation is rejected because the user received the readable indicia outside the area of validity. Alternatively, in some embodiments, if the user receives the readable indicia outside the valid geographical area and submits the readable indicia after returning to the valid geographical area, the readable indicia is processed to accept the user's donation. In some embodiments, an external server as described herein may be programmed to adjust various features associated with the readable indicia (validity time period, donation amounts, permissible number of donations, geographical area of validity, or the like).

Additionally, the readable indicia may be associated with a maximum time period between receiving the readable indicia and submitting a payment (e.g., submitting a donation request form) or initiating processing of the readable indicia. Therefore, if the user exceeds the maximum period between receiving the readable indicia and submitting the payment (or initiating processing of the readable indicia), the user's donation is rejected. A rejection message may be presented on the user's mobile device indicating the donation is rejected because the user exceeded the maximum time period between receiving the readable indicia and submitting the payment (or initiating processing of the readable indicia).

In some embodiments, the readable indicia comprises visual indicia, e.g., a barcode, a Quick Response (QR) code, or the like. The readable indicia may comprise any one-dimensional or two-dimensional code. Therefore, the user may use a portable mobile communication device or apparatus (“mobile device”) that comprises an image-capturing component (e.g., a camera) to capture the image of the readable indicia. In some embodiments, this readable indicia is stored in the mobile device. In other embodiments, this readable indicia is automatically transmitted to an external server. In embodiments where the readable indicia is in electronic form, the readable indicia may be dynamically generated after the user (or the agent) selects an option to view the readable indicia. For example, the agent may dynamically generate the readable indicia on the agent's mobile device based on information provided by the user (e.g., name of fund, amount of donation, recurring donation, name of user, user's contact information or the like). Additionally or alternatively, the user may generate the readable indicia on the user's mobile device by selecting a selectable options received via email, text or multimedia message, or the like.

In some embodiments, a user may answer a series of questions (e.g., a feedback form) at a kiosk (e.g., a kiosk at a merchant) in order to receive the readable indicia associated with making a donation. Once the user has completed answering the questions, the kiosk presents readable indicia to the user. The user may receive information associated with the presented readable indicia using a mobile device.

The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, or the like). A user may bring a mobile device in close proximity to the tag in order to receive information (e.g., readable indicia) associated with the tag.

In some embodiments, the readable indicia may be processed by at least one of the mobile device or the external server to determine a link (e.g., a hyperlink) associated with the readable indicia. The user interface of the mobile device may present the link and may prompt the user to visit the link. The link may transport the user to a user interface page (e.g., a donation request form) for initiating the process of making the donation. The user interface page may prompt the user to enter information (e.g., user's name, contact information, payment amount, payment method, account information, recurring payment option, or the like). In some embodiments, the link may transport the user to an account user interface (e.g., financial institution account, social network account or the like). The user may input the user's login or authentication credentials associated with the user's account. When the user inputs the user's credentials, the user's information (e.g., user's name, contact information, payment amount, payment method, account information, recurring payment option, or the like) may be automatically input or populated onto the user interface page (e.g., the donation request form). Therefore, the user may submit the donation request form from within the user's account (and without manually entering any user input). The user may choose to manually modify the automatically populated input. As used herein, the recurring payment option enables the user to make recurring donations periodically (e.g., monthly, yearly, or the like).

As indicated previously, in some embodiments, at block 110, the method additionally comprises receiving authentication credentials. In some embodiments, in response to receiving the readable indicia, the mobile device initiates an authentication prompt (e.g., at the link described above) for receiving the authentication credentials from the user. For example, the authentication prompt may comprise a prompt or challenge question for which the user knows the answer. These authentication credentials may have been previously received from the non-profit organization separately from the readable indicia. For example, the non-profit organization may have sent a personal identification number (“PIN”) code to the user via mail, email, text or multimedia message, or the like. As a further example, the user may have previously logged onto the non-profit organization's website in order to set up authentication credentials for processing the readable indicia for making a payment. As a further example, the authentication credentials may be associated with a user account (e.g., financial institution account, social networking account, or the like).

Subsequently, the user inputs authentication credentials onto a user interface of the mobile device. In some embodiments, this input may comprise entering a password. In some embodiments, this input may comprise entering an alias. For example, the alias may comprise a phone number, email address, or social networking identification information associated with the user. In other embodiments, this input may comprise entering an answer to a question. In still other embodiments, this input may comprise selecting a picture. In some embodiments, the received authentication credentials are stored in the mobile device. In other embodiments, the received authentication credentials are automatically transmitted to an external server. In some alternate embodiments, the user may input authentication credentials on a user interface of the mobile device prior to the mobile device receiving the readable indicia described herein. Therefore, in some embodiments, the user may login or authenticate into the user's account (financial institution account, social networking account, or the like) and then select an option to view a payment or donation request form. The information on the form may be populated based on information associated with the user's account (the user may modify this information). Either prior to or after selecting the option to view the form, the mobile device may receive the readable indicia. The readable indicia may be processed and information associated with the readable indicia may be integrated into the form. Subsequently, the user submits the form to authorize the donation.

At block 120, the method comprises processing the readable indicia to authorize a payment to the non-profit organization. In embodiments where the readable indicia is stored in the mobile device, the processing of the readable indicia occurs in the mobile device. In embodiments where the readable indicia is transmitted to an external server, the processing of the readable indicia occurs outside the mobile device, i.e., at the external server. The processing may comprise processing (or settling or clearing) the payment, such that the payment amount is debited from the user's account and transmitted to an account associated with the non-profit organization. Alternatively, the payment may be transmitted to an alias associated with the non-profit organization, and routed to an account associated with the alias. Additionally or alternatively, the processing may comprise comparing the information associated with the readable indicia (e.g., an alias) to information stored in at least one of the mobile device or the external server to determine whether to authorize a payment to the non-profit organization.

As described previously, in other embodiments, the user is prompted to enter authentication credentials on the mobile device user interface. In such embodiments, the method, at block 120, further comprises processing the authentication credentials to authorize a payment. In embodiments where the authentication credentials are stored in the mobile device, the processing of the authentication credentials occurs in the mobile device. In embodiments where the authentication credentials are transmitted to an external server, the processing of the authentication credentials occurs outside the mobile device, i.e., at the external server. The processing may comprise comparing the authentication credentials to information stored in at least one of the mobile device or the external server.

In some embodiments, the authentication credentials are comprised in the readable indicia. Therefore, the authentication credentials input by the user are compared to the authentication credentials extracted from the readable indicia. In other embodiments, the authentication credentials are not comprised in the readable indicia. In such embodiments, the authentication credentials input by the user are compared to information (e.g., authentication credentials) stored in at least one of the mobile device or external server or accessed by at least one of the mobile device or external server from an external datastore.

If the mobile device or the external server determines a match between the authentication credentials input by the user and the authentication credentials either extracted from the readable indicia or stored in at least one of the mobile device or external server, the payment is authorized. In some embodiments, the payment is an electronic payment. In other embodiments, the user may select an option to have a physical check for the donation amount mailed to the non-profit organization's mailing address. In alternate embodiments, the payment is authorized without executing the authentication step described herein. In some embodiments, after the payment is authorized (or after the payment is cleared a predetermined period after authorized), the system is configured to transmit an electronic receipt to the user via email, text message, or the like. The electronic receipt indicates to the user that the payment has been authorized and/or cleared.

The payment issued by the donor to the non-profit organization may not be available (or visible) to the organization (or the agent) until the payment clears. Therefore, when the organization (or agent) views the destination payment account, the organization will not be able to view the payment credited to the account until the payment is cleared. There may be a time period (e.g. a few hours, a day, a few days, or the like) between authorization of the payment by the donor (e.g., submitting a payment via the user's mobile device) and clearance of the payment by the user's financial institution. As used herein, submitting a payment via the user's mobile device may comprise submitting a completed donation request form.

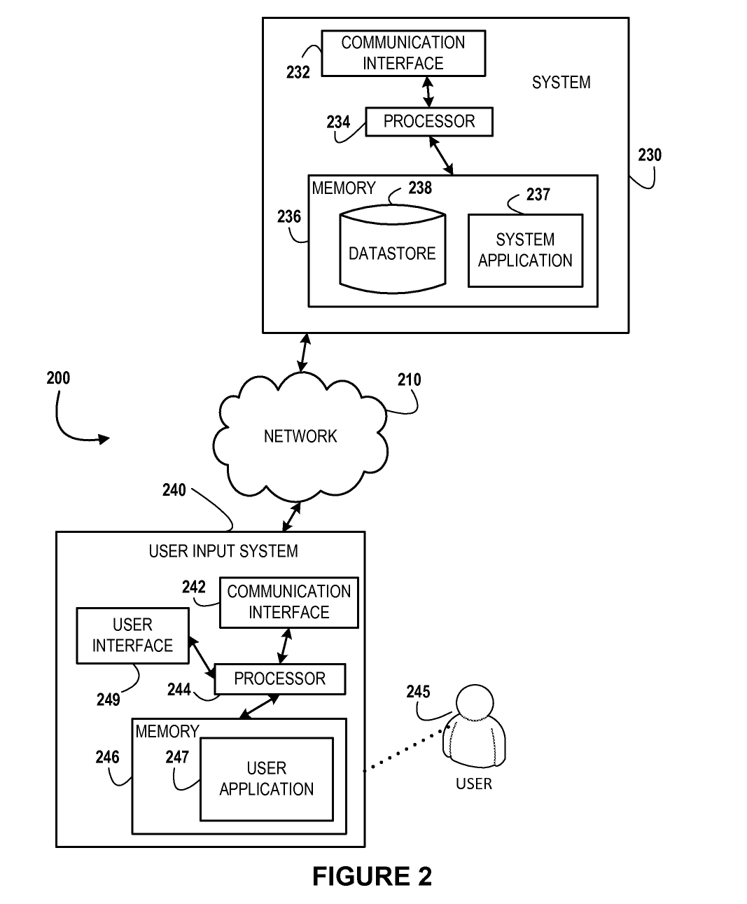

Referring now to FIG. 2, FIG. 2 presents an exemplary block diagram of the system environment 200 for implementing the process flow 100 described in FIG. 1, in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The system 230 may be the external server described herein. The user application 247 and/or the system application 237 may incorporate one or more parts of the process flow 100 or any other function described herein. In some embodiments, the user 245 may represent the agent described herein, and the user input system 240 may represent an agent input system (e.g., a mobile device). The agent may use the agent input system to receive readable indicia from a system associated with the non-profit organization. Additionally or alternatively, the agent may use the agent input system to generate readable indicia. The agent may also use the agent input system to present the readable indicia to the user.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. The external server may be associated with an entity (e.g., a financial institution, a non-profit organization, or the like). In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for processing readable indicia for fundraising, the apparatus comprising:
a memory;
a processor; and
a computing module stored in the memory, executable by the processor, and configured to:
receive information associated with readable indicia associated with a non-profit organization; and
process the readable indicia to authorize a payment to the non-profit organization, wherein the readable indicia is valid for a predetermined period.

2. The apparatus of claim 1, wherein the readable indicia is associated with an agent of the non-profit organization, wherein the readable indicia enables tracking of payments associated with the agent.

3. The apparatus of claim 1, wherein the readable indicia is associated with a geographical area, wherein the readable indicia enables tracking of payments associated with the geographical area.

4. The apparatus of claim 1, wherein the readable indicia is associated with at least of a financial institution account or an alias, wherein the payment is issued to the at least one of the financial institution account or the alias.

5. The apparatus of claim 1, wherein the readable indicia is associated with at least one of an item of value or a cause, and wherein the readable indicia enables tracking of payments associated with the at least one of the item of value or the cause.

6. The apparatus of claim 1, wherein the readable indicia is associated with a predetermined minimum payment and a predetermined maximum payment, wherein the module is configured to reject a payment lesser than the predetermined minimum payment or greater than the predetermined maximum payment, and wherein the readable indicia limits a number of payments such that the number of payments is not greater than a predetermined number.

7. The apparatus of claim 1, wherein when a period between the module receiving the information associated with the readable indicia and the processing of the readable indicia exceeds a predetermined period, the payment is rejected.

8. The apparatus of claim 1, wherein the readable indicia is associated with a geographical area, and wherein if the module receives the information associated with the readable indicia outside the geographical area, the payment is rejected.

9. The apparatus of claim 1, wherein the readable indicia is associated with a geographical area, and wherein if the module receives the information associated with the readable indicia in the geographical area but the payment is submitted outside the geographical area, the payment is rejected.

10. The apparatus of claim 1, wherein the readable indicia comprises a Quick Response (QR) code.

11. The apparatus of claim 1, wherein the apparatus comprises a portable mobile communication apparatus that comprises an image-capturing component, and wherein the image of the readable indicia is captured by the portable mobile communication apparatus, wherein the processing occurs either inside or outside the portable mobile communication apparatus.

12. The apparatus of claim 1, wherein the readable indicia comprises electronic readable indicia, and wherein the electronic readable indicia is transmitted via at least one of email or text or multimedia message, or is presented via a portable mobile communication device associated with an agent of the non-profit organization.

13. The apparatus of claim 1, wherein the readable indicia comprises physical readable indicia, and wherein the physical readable indicia is printed on an object.

14. The apparatus of claim 1, wherein the module is further configured to:
extract a link from the readable indicia; and
initiate a user interface associated with the link.

15. The apparatus of claim 14, wherein the user interface comprises a user interface associated with a user's account, wherein the module is further configured to receive authentication credentials to the user's account, and wherein the module is configured to populate a payment form based on information associated with the user's account, wherein the account comprises a financial institution account.

16. The apparatus of claim 1, wherein the module is further configured to issue the payment to a destination account associated with the non-profit organization after clearance of the payment.

17. The apparatus of claim 1, wherein the module is further configured to:
receive authentication credentials associated with the payment; and wherein the module configured to process the readable indicia is further configured to:
process the readable indicia and the authentication credentials to authorize the payment.

18. The apparatus of claim 1, wherein the readable indicia is comprised in a tag that transmits information wirelessly.

19. A method for processing readable indicia for fundraising, the method comprising:
receiving information associated with readable indicia associated with a non-profit organization; and
processing the readable indicia to authorize a payment to the non-profit organization, wherein the readable indicia is valid for a predetermined period.

20. A computer program product for processing readable indicia for fundraising, the computer program product comprising:
a non-transitory computer-readable medium comprising a set of codes for causing a computer to:
receive information associated with readable indicia associated with a non-profit organization; and
process the readable indicia to authorize a payment to the non-profit organization, wherein the readable indicia is valid for a predetermined period.
